(19) United States
(12) Patent Application Publication
(10) Pub. No.: US 2009/0195356 A1
(43) Pub. Date: Aug. 6, 2009

(54) Power Estimation of an Active RFID Device

(75) Inventor: Mark E. Tuttle, Meridian, ID (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: Keystone Technology Solutions, LLC

(21) Appl. No.: 12/024,351

(22) Filed: Feb. 1, 2008

(51) Int. Cl. H04Q 5/22

(52) U.S. Cl. 340/10.1

(57) ABSTRACT

Methods and apparatus, including computer program products, for power estimating of an active RFID device. A method includes, in a radio frequency identification (RFID) interrogator, interrogating a RFID device, receiving an identification code, times and temperature data from the RFID device in response to the interrogation, and estimating a remaining battery life of a battery in the RFID device. A system includes a radio frequency identification (RFID) device having a store of times and temperature data, and a RFID interrogator programmed to interrogate the RFID, receive the times and temperature data, and estimate a remaining battery life of a battery in the RFID device from the times and temperature data.

### BACKGROUND

The present invention relates to radio frequency identification (RFID), and more particularly to power estimating of an active RFID device.

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF (radio frequency) portion of the electromagnetic spectrum is used to transmit signals. A typical RFID system includes an antenna and a transceiver, which reads the radio frequency and transfers the information to a processing device (reader) and a transponder, or RF label, which contains the RF circuitry and information to be transmitted. The antenna enables the integrated circuit to transmit its information to the reader that converts the radio waves reflected back from the RFID device into digital information that can then be passed on to computers that can analyze the data.

### SUMMARY

The present invention provides methods and apparatus, including computer program products, for power estimating of an active RFID device.

In general, in an aspect, the invention features a method including, in a radio frequency identification (RFID) interrogator, interrogating a RFID device, receiving an identification code, times and temperature data from the RFID device in response to the interrogation, and estimating a remaining battery life of a battery in the RFID device.

In another aspect, the invention features a method including, in a radio frequency identification (RFID) device having a memory, temperature sensor and battery, periodically storing measured ambient temperatures, and estimating a remaining battery life from the stored temperatures.

In another aspect, the invention features a method including, in a radio frequency identification (RFID) interrogator, interrogating a RFID device, receiving an identification code, times, temperature data and battery voltage data from the RFID device in response to the interrogation, and estimating a remaining battery charge in the RFID device.

In another aspect, the invention features a system including a radio frequency identification (RFID) device having a store of times and temperature data, and a RFID interrogator programmed to interrogate the RFID, receive the times and temperature data, and estimate a remaining battery life of a battery in the RFID device from the times and temperature data.

In another aspect, the invention features a system including a radio frequency identification (RFID) device having a store of times and temperature data, and a RFID interrogator programmed to interrogate the RFID, receive the times and temperature data, and estimate a remaining battery voltage of a battery in the RFID device from the times and temperature data.

Other features and advantages of the invention are apparent from the following description, and from the claims.

### BRIEF DESCRIPTION OF THE DRAWINGS

FIG. 1 is a block diagram of an exemplary active radio frequency identification (RFID) device.

FIG. 2 is a block diagram of an exemplary RFID interrogator.

FIG. 3 is an exemplary graph.

FIG. 4 is a flow diagram.

Like reference numbers and designations in the various drawings indicate like elements.

### DETAILED DESCRIPTION

Radio frequency identification (RFID) is a technology that incorporates the use of electromagnetic or electrostatic coupling in the radio frequency (RF) portion of the electromagnetic spectrum to uniquely identify an object, animal, or person.

RFID devices can be intelligent or just respond with a simple identification (ID) to radio frequency (RF) interrogations. The RFID device can contain memory. This memory can be loaded with data either via an RFID interrogator, or directly by some integrated data gathering element of the RFID device, for example, an environmental sensor. This data is retrieved some time later.

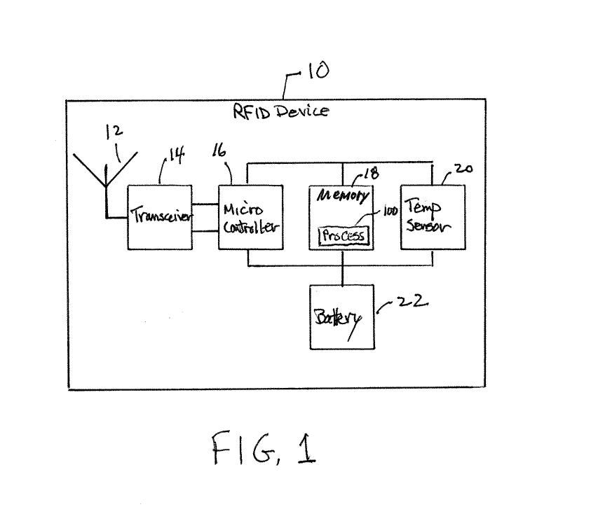

As shown in FIG. 1, an exemplary active RFID device 10 includes an antenna 12, a transceiver 14, a microcontroller 16, a programmable memory 18, a temperature sensor 20 and battery 22. Programmable memory 18 includes a battery life expectancy process 100, described below. Temperature sensor 20 senses and transmits temperature data to memory 18 at user-selectable intervals of time. When triggered by RF interrogation via transceiver 14, microcontroller 16 fetches the data (i.e., time stamps and temperatures) from memory 18 and sends it out to an RFID interrogator as multiplexed data packets from transceiver 14. In this manner, a historical temperature log stored in memory 18 in the RFID device 10 can be retrieved. Temperature logging is limited by the size of memory 18 and/or life of battery 22.

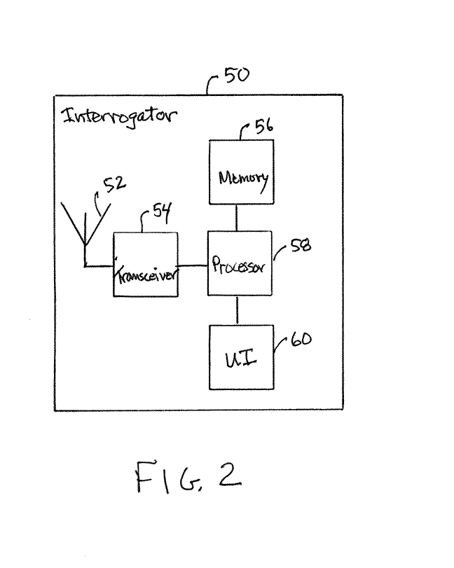

As shown in FIG. 2, an exemplary RFID interrogator 50 includes an antenna 52, transceiver 54, memory 56, processor 58 and optional user interface (UI) 60. The RFID interrogator 50 performs Time Division Multiplexing (TDM) with the transceiver 54 and antenna 52. Data (e.g., time stamp and temperature) downloaded from the RFID device 10 can be stored in memory 56.

The RFID interrogator 50 can be used to program the RFID device 10 to record or log a temperature in memory 18. The RFID interrogator 50 can also predict an expected life of battery 22 using a time v. temperature curve, described below.

Chemical reactions internal to a battery are driven either by voltage or temperature. In general, the hotter the battery, the faster chemical reactions will occur. High temperatures can thus provide increased performance, but at the same time the rate of the unwanted chemical reactions will increase resulting in a corresponding loss of battery life. The shelf life and charge retention depend on the self discharge rate and self discharge is the result of an unwanted chemical reaction in the cell. Similarly adverse chemical reactions such as passivation of the electrodes, corrosion and gassing are common causes of reduced cycle life. Temperature therefore affects both the shelf life and the cycle life as well as charge retention since they are all due to chemical reactions. Even batteries that are specifically designed around high temperature chemical reactions are not immune to heat induced failures which are the result of parasitic reactions within the cells.

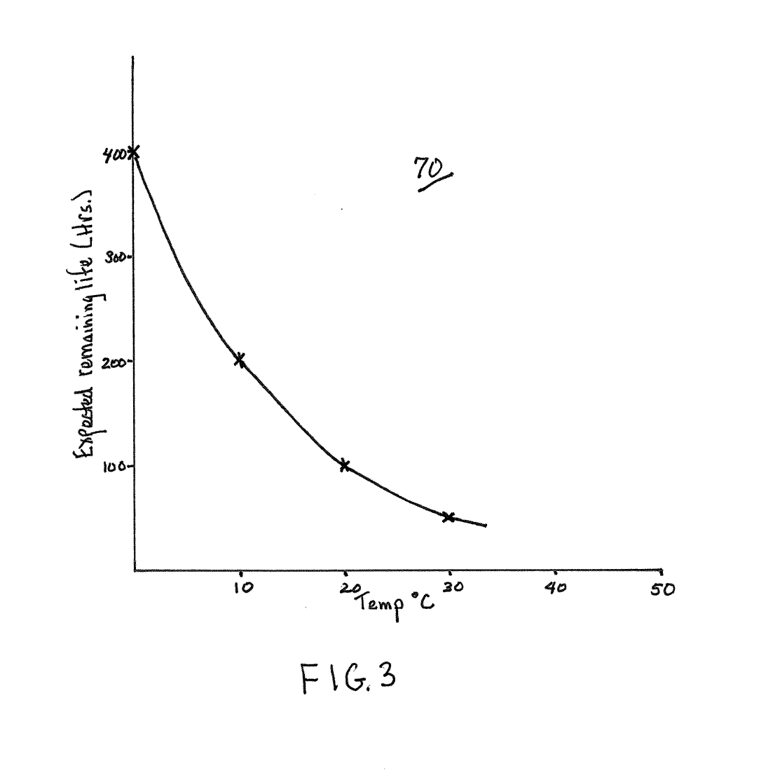

As shown in FIG. 3, assuming constant current draw, a remaining life of a battery is generally a function of a time v. temperature curve 70 the battery experienced before a current temperature measurement is performed, along with an estimate/extrapolation of a future temperature that one can expect the battery to experience throughout the rest of its life. In that manner, the life of a battery is much like the life of the perishable goods these RFID devices are sometimes intended to track. The integration of the time v. temperature curve 70 can predict the remaining life of the battery, just as it can predict the remaining life of the monitored perishable goods, depending on estimated future temperatures. For example, if the battery experiences 100° C. for 20 hours, that will significantly reduce the battery life expectancy, even if the battery temperature comes back down to 20° C. for its latest measurement (and whether it's expected to stay there for the rest of its life). And each battery has a predicted life at an ideal temperature and a corresponding shorter or longer life expectancy at temperatures below or above the ideal temperature.

In one particular example, an expected battery life can be predicted based in the last measured temperature by the temperature sensor 20 in the RFID device 10. In this example, it is presumed that the last measured temperature reflects an approximate temperature of most past and future temperature readings by the sensor 20. For example, using curve 70, if the last measured temperature is 20° C., and we assume past temperatures were approximately 20° C. and future temperature measurements will be approximately 20° C., the battery 22 may be expected to have a remaining life of 100 hours.

In another particular example, an expected battery life can be predicted from averaging all the temperatures measured by the sensor 20 at the time the RFID device 10 is interrogated. In this particular example, it is presumed that the average of future temperatures measured by the sensor 20 approximate the average of past measured temperatures by the sensor 20. For example, using curve 70, if an average temperature of all temperatures downloaded from the RFID device 10 is 30° C., and we assume an average of temperatures taken in the future will approximate 30° C., the battery 22 may be expected to have a remaining life of 50 hours.

In still other examples, times of temperature measurements stored by the RFID device 10 can be used in conjunction with temperature averaging to predict a remaining battery life. In other examples, time and temperature data can be used in conjunction with specific battery information, such as the amp-hour rating of the battery, and/or the battery chemistry (e.g., Li-ion or Ni—Cd, and so forth), and/or the battery's total life expectancy, and/or the battery's voltage output, and so forth), to predict an expected remaining battery life.

In operation, upon interrogation of the RFID device 10, the RFID 50 can use the last temperature reading or the historical time/temperature data, and in some instances, one or more parameters, to calculate the remaining life of the battery, using one or more of the above-described predictions of the average future temperatures of the battery (e.g. assuming the current temperature will continue into the future or assuming the time-averaged temperature the RFID device has seen in the past will continue into the future).

The operation may occur in the RFID device 10 itself, wherein, the RFID device 10 can calculate the remaining battery life based on its stored time/temperature data and optionally the information about the battery capacity that the RFID device 10 knows.

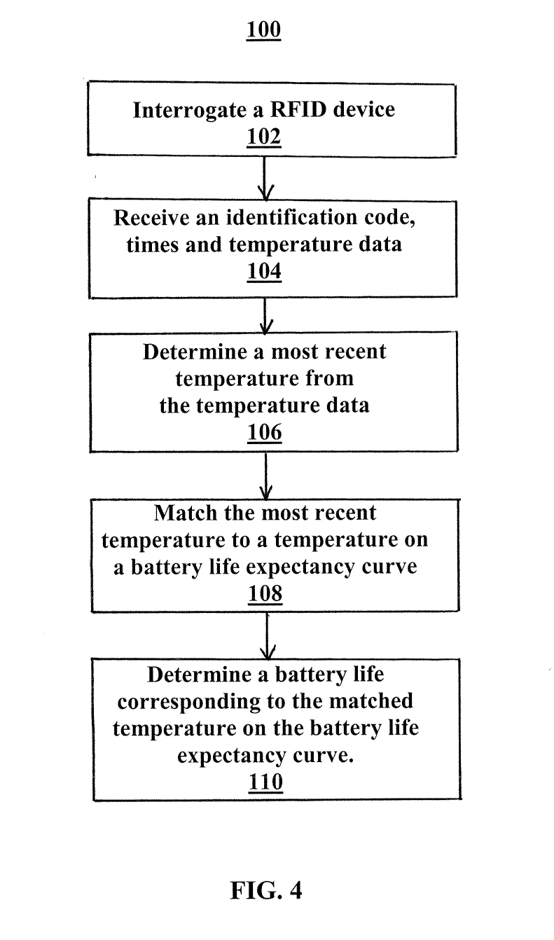

As shown in FIG. 4, process 100 includes, in a radio frequency identification (RFID) interrogator, interrogating (102) a RFID device. Process 100 receives (104) an identification code, times and temperature data from the RFID device in response to the interrogation.

Process 100 determines (106) a most recent temperature from the temperature data.

Process 100 matches (108) the most recent temperature to a temperature on a battery life expectancy curve. In another example, the temperature data is averaged and used for subsequent actions. Process 100 determines (110) a battery life corresponding to the matched temperature on the battery life expectancy curve. The remaining battery life is the determined battery life.

In another example, process 100 can be adapted to predict or calculate the remaining battery charge in the RFID device 10, knowing that the remaining battery charge decreases as the temperature drops. More particularly, as the temperature drops, the chemical reaction rate in the battery drops, which may have the effect of preserving the battery life but it also drops the voltage potential of the battery. Knowing the type of battery, along with either a recent temperature or an average temperature experienced by the battery, process 100 can estimate a remaining charge using, for example, a voltage v. time curve. In this manner, a RFID interrogator can predict if the RFID device battery has enough charge at the current temperature or average temperature to continue powering the RFID device for some period of time.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method comprising:
in a radio frequency identification (RFID) interrogator, interrogating a RFID device;
receiving an identification code, times and temperature data from the RFID device in response to the interrogation; and
estimating a remaining battery life of a battery in the RFID device.

2. The method of claim 1 wherein estimating comprises:
determining a most recent temperature from the temperature data; and
predicting the remaining battery life from the most recent temperature.

3. The method of claim 2 wherein predicting the remaining battery life comprises:
matching the most recent temperature to a temperature on a battery life expectancy curve; and
determining a battery life corresponding to the matched temperature on the battery life expectancy curve.

4. The method of claim 3 wherein the battery life expectancy curve is plot of time and temperature.

5. The method of claim 3 wherein the remaining battery life is the determined battery life.

6. The method of claim 3 further comprising receiving a battery indicator from the RFID device.

7. The method of claim 6 wherein the remaining battery life is calculated from the determined battery life and battery indicator.

8. The method of claim 1 wherein estimating comprises:
determining an average temperature from the temperature data; and
predicting the remaining battery life from the average temperature.

9. The method of claim 8 wherein predicting the remaining battery life comprises:
matching the average temperature to a temperature on a battery life expectancy curve; and
determining a battery life corresponding to the matched temperature on the battery life expectancy curve.

10. The method of claim 9 wherein the battery life expectancy curve is plot of time and temperature.

11. The method of claim 9 wherein the remaining battery life is the determined battery life.

12. The method of claim 9 further comprising receiving a battery indicator from the RFID device.

13. The method of claim 12 wherein the remaining battery life is calculated from the determined battery life and battery indicator.

14. A method comprising:
in a radio frequency identification (RFID) device having a memory, temperature sensor and battery, periodically storing measured ambient temperatures; and
estimating a remaining battery life from the stored temperatures.

15. The method of claim 14 wherein estimating comprises:
loading a most recent stored temperature; and
predicting the remaining battery life from the most recent stored temperature.

16. The method of claim 15 wherein predicting comprises:
matching the most recent stored temperature to a temperature on a battery life expectancy curve; and
setting the remaining battery life to the battery life corresponding to the matched temperature.

17. The method of claim 14 wherein estimating comprises:
determining an average temperature from the stored temperatures; and
setting the remaining battery life to a battery life corresponding to the average temperature on a battery life expectancy curve.

18. A method comprising:
in a radio frequency identification (RFID) interrogator, interrogating a RFID device;
receiving an identification code, times, temperature data and battery voltage data from the RFID device in response to the interrogation; and
estimating a remaining battery charge in the RFID device.

19. The method of claim 18 wherein estimating comprises:
setting the remaining battery charge to a battery charge corresponding to a last measured battery voltage on a battery charge life expectancy curve.

20. The method of claim 18 wherein estimating comprises:
determining an average voltage from the received voltage data; and
setting the remaining battery charge to a battery charge corresponding to the average voltage on a battery charge life expectancy curve.

21. A system comprising:
a radio frequency identification (RFID) device having a store of times and temperature data; and
a RFID interrogator programmed to interrogate the RFID, receive the times and temperature data, and estimate a remaining battery life of a battery in the RFID device from the times and temperature data.

22. The system of claim 21 wherein estimating comprises:
determining a most recent temperature from the temperature data;
matching the most recent temperature to a temperature on a battery life expectancy curve; and
determining a battery life corresponding to the matched temperature on the battery life expectancy curve.

23. The system of claim 21 wherein estimating comprises:
determining an average temperature from the temperature data;
matching the average temperature to a temperature on a battery life expectancy curve; and
determining a battery life corresponding to the matched temperature on the battery life expectancy curve.

24. A system comprising:
a radio frequency identification (RFID) device having a store of times and temperature data; and
a RFID interrogator programmed to interrogate the RFID, receive the times and temperature data, and estimate a remaining battery voltage of a battery in the RFID device from the times and temperature data.

25. The system of claim 24 wherein estimating comprises:
determining a most recent temperature from the temperature data;
matching the most recent temperature to a temperature on a battery voltage expectancy curve; and
determining a battery voltage corresponding to the matched temperature on the battery voltage expectancy curve.

26. The system of claim 24 wherein estimating comprises:
determining an average temperature from the temperature data;
matching the average temperature to a temperature on a battery voltage expectancy curve; and
determining a battery voltage corresponding to the matched temperature on the battery voltage expectancy curve.
